(19) United States
(12) Patent Application Publication
(10) Pub. No.: US 2006/0233987 A1
(43) Pub. Date: Oct. 19, 2006

(54) Laminate having a high oxygen transmission rate

(75) Inventor: Edward Lee Mumpower, Moore, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Cryovac, Inc.

(21) Appl. No.: 11/109,003

(22) Filed: Apr. 19, 2005

(51) Int. Cl. B32B 27/32

(52) U.S. Cl. 428/35.2; 428/35.7

(57) ABSTRACT

The invention is a trap-printable laminate having an OTR that is sufficiently high to help facilitate the passage of oxygen through the laminate without sacrificing the properties of the laminate that are necessary for lamination, printing, and heat sealing to a support member, such as a tray. In one embodiment, the laminate has an OTR of at least 4,000, cc at STP/m²/24 hr/atm. The laminate may be particularly useful in high oxygen packaging applications where it may be desirable to have a product bloom from exposure to oxygen. The high OTR of the laminate may allow oxygen to pass through the laminate and interact with portions of a product that may be in direct contact with the laminate.

### BACKGROUND OF THE INVENTION

The invention relates generally to film laminates having a high rate of oxygen transmission (OTR) and more particularly to a trap printed film laminate having a high OTR.

Various forms of packaging, particularly for food products, use a relatively rigid substrate, such as a foam tray, in which a product is supported. If the product is to be displayed, the packaging may also include a lid or lidstock that is used to cover and enclose the product within the tray. The lid may comprise a transparent film or laminate that is bonded to the tray around the product, generally by forming a heat seal between the film and tray, to thereby enclose the product within the package.

In some packaging applications it may be desirable to enclose the food product in a high oxygen atmosphere. For example, in packaging meat, the atmosphere in the sealed package may comprise about 80% by volume oxygen and about 20% by volume carbon dioxide in order to inhibit the growth of harmful microorganisms and extend the time period in which the meat retains its attractive red (“bloom”) coloration. Oxygen and carbon dioxide barrier attributes may be imparted to a film by incorporating, for example as a film layer, one or more resins having low permeability to oxygen. Such films are generally referred to as “barrier films” and may be designed to prevent oxygen from entering or escaping from the interior of the sealed package. The barrier film helps to maintain a high oxygen atmosphere within the sealed package during any subsequent storage, shipment, or display at the point of sale.

In some cases, the product may be packaged in a high oxygen atmosphere in a partially bloomed or relatively un-bloomed state. The high oxygen atmosphere will facilitate further blooming during shipment and display of the packaged product. In some cases, a portion of the product may be in contact with the lidstock. At points of contact, the product may have insufficient interaction with the high oxygen atmosphere. As a result, the meat may fail to bloom fully, which may result in a brown coloring. In some cases, the meat may become oxygen starved, which may result in a purplish or blue coloring. In other cases, the meat may be packaged in a “bloomed” state. Contact with the lidstock may cause the meat to turn from a fully bloomed coloring to a brown coloring. Such colorings may result in the product being undesirable in the mind of a consumer, and as a result, the product may fail to sell.

It may also be desirable for the lidstock to be printed. Such printing provides important information to the end-user of the packaged food—information such as the ingredients of the packaged food, the nutritional content, package opening instructions, food handling and preparation instructions, and food storage instructions. The printing may also provide a pleasing image and/or trademark or other advertising information to enhance the retail sale of the packaged product.

Such printed information may be placed on the outside surface of the lidstock. However, such surface printing is directly exposed to a heated bar during the heat seal operation that seals the lid to the support member. As a result, the surface printing may become smeared or otherwise degraded. A surface printing is also exposed to other physical abuses during distribution and display of the packaged product. Such abuse may also degrade the clarity and presentation of the printed image. Laminates having a trap-printed image have been developed to overcome some of these printing difficulties. U.S. Pat. No. 6,627,273 describes a laminate lidstock having printed image trapped between a barrier film and a sealant film. The printed film typically requires sufficient stiffness so that an image may be printed on the film. Although this laminate performs well, it includes a barrier film that may prevent the product from fully blooming at points of contact between the product and the film.

Thus, there exists a need for a lidstock having a printed image that helps facilitate adequate oxygen transfer to a meat product at points of contact between the meat and the lidstock.

### BRIEF SUMMARY OF THE INVENTION

The invention is a trap-printable laminate having an oxygen transmission rate (OTR) that is sufficiently high to help facilitate the passage of oxygen through the laminate without sacrificing the properties of the laminate or its constituents that are necessary for lamination, printing, and heat sealing to a support member, such as a tray. In one embodiment, the laminate has an OTR of at least 4,000 cc at STP/m²/24 hr/atm. The laminate may be particularly useful in high oxygen packaging applications where it may be desirable to have a product bloom or remain bloomed from exposure to oxygen. The high OTR of the laminate may allow oxygen to pass through the laminate and interact with portions of a product that may be in direct contact with the laminate.

In one embodiment, the laminate may comprise a first film having an inner surface adhesively bonded to an inner surface of a second film. In this embodiment, each film has a sufficiently high OTR so that the laminate will have the desired OTR. Each film may also have a modulus that helps facilitate lamination of the films together. In one alternative embodiment, the first film may have an oxygen transmission rate of at least 7,500 cc at STP/m²/24 hr/atm and a modulus of at least 20,000 psi, and the second film may have an oxygen transmission rate of at least 7,000 cc at STP/m²/24 hr/atm and a modulus of at least 45,000 psi. The resulting laminate has an OTR of at least 4,000 cc at STP/m²/24 hr/atm. In another embodiment of the invention, the laminate has an OTR of at least 5,000 cc at STP/m²/24 hr/atm.

In some embodiments, the first film comprises a sealant film that may be laminated to a support member, such as a tray. The sealant film, while having a desired OTR, also includes a sealant layer comprising a polymeric material that may be heat sealable to the support member. In some embodiments, the sealant film may also include a first bulk layer that may be laminated directly to the second film.

In another embodiment, the second film comprises a print film having an inner surface for receiving a print image thereon. The print film, while having a desired OTR, may also have the desired stiffness for lamination and the printing process. In some embodiments, the print film may include an outer abuse layer having a melting point that is greater than the temperatures used to heat seal the laminate to a support member. The print film may also include a second bulk layer having sufficient thickness to help improve the strength of the print film. The print film may also include a stiffening layer having sufficient modulus to help improve the stiffness of the print film. In some embodiments, the trapped image may be printed onto the stiffening layer.

In one embodiment of the invention, the laminate is combined with a support member to produce a package for enclosing a product therein. The high oxygen transmission rate of the laminate may allow oxygen to pass through the laminate and interact with a product disposed within the interior space of the package. As a result, the laminate may help facilitate blooming of the product or maintaining the product in a bloomed state, even at points where the product is in contact with the laminate.

Thus, the invention provides a laminate having a sufficiently high OTR that allows oxygen to pass through the laminate, without sacrificing the stiffness and strength properties in the films comprising the laminate that make it possible to laminate and print the films.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a cross-sectional side view of a trap-printable laminate comprising a print film adhesively bonded to a sealant film;

FIG. 2 is a graphical illustration of a package containing a food product and a lidstock comprising the laminate of the invention;

FIG. 3 is a cross-sectional side view of the package of FIG. 2; and

FIG. 4 is a cross-sectional side view of an alternative embodiment of the trap-printable laminate comprising a print film adhesively bonded to a sealant film.

### DETAILED DESCRIPTION OF THE INVENTION

The present invention now will be described more fully hereinafter with reference to the accompanying drawings, in which some, but not all embodiments of the invention is shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

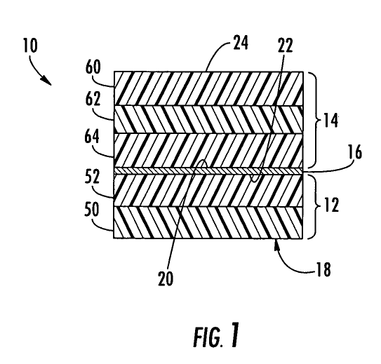

With reference to FIG. 1, a trap-printable laminate having high oxygen transmission rate (OTR) is illustrated and broadly designated as reference number 10. In this embodiment, the laminate 10 includes a first film 12, also referred to as a “sealant film” that is adhesively laminated to a second film 14, also referred to as a “print film.” An adhesive layer 16 may be sandwiched between the sealant film 12 and the print film 14.

Trap-printable laminate 10 has a sufficiently high OTR so that a desired level of oxygen may travel through the laminate. In some embodiments, the laminate may have an OTR of at least 4,000, 5,000, 6,000, cc (at standard temperature and pressure (STP))/m²/24 hr/atm or greater, as measured according to ASTM D-3985. Unless otherwise indicated, all references to OTR in this application have been determined according to ASTM D-3985 at 73° F. and 0% relative humidity. To achieve the desired high OTR for the laminate, the sealant film, print film, and adhesive layer each have a sufficiently high OTR, without sacrificing the requisite properties necessary for applying a print image, laminating the films, and sealing the laminate to a support member.

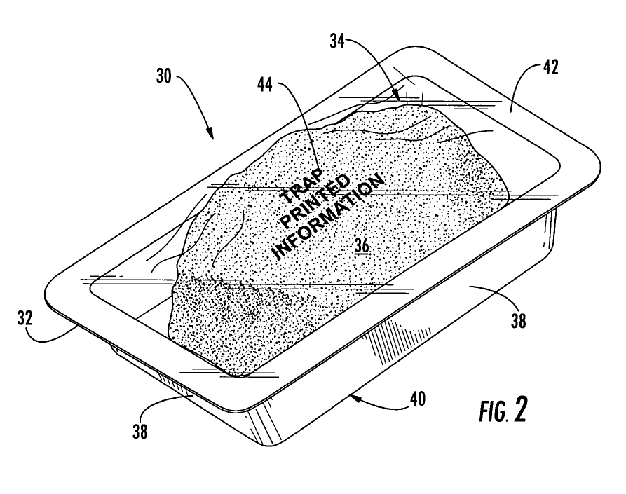

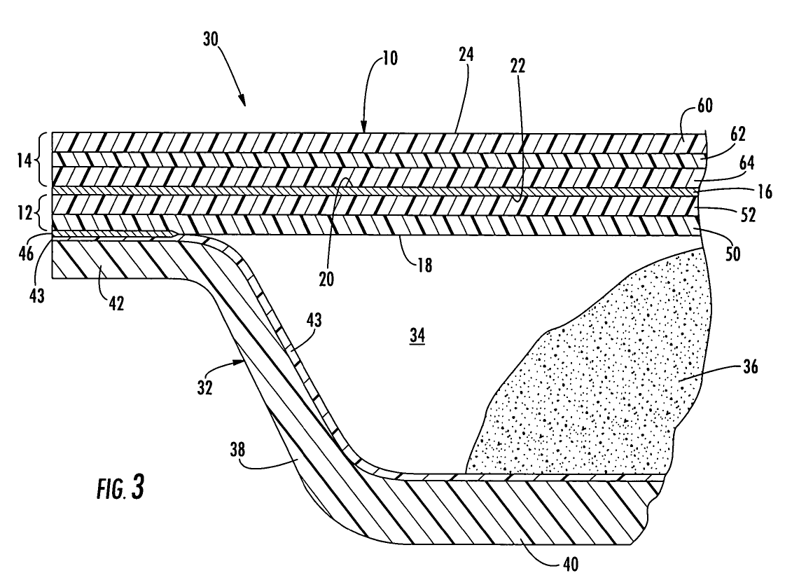

With reference to FIGS. 2 and 3, a package having a lidstock comprising the laminate of the invention is illustrated and broadly designated as reference number 30. Package 30 includes product support member 32 having a cavity 34 formed therein and a product 36 disposed within the cavity. Support member 32 is preferably in the form of a tray having side walls 38 and a base 40 which define the cavity 34, and further includes a peripheral flange 42 extending outwardly from the cavity. Laminate 10 forms a lid on the package 30 and encloses the product 36 within cavity 34 by being heat-welded to flange 42. Trap print image 44 is disposed between the sealant film and the print film.

Support member 32 can have any desired configuration or shape, e.g., rectangular, round, oval, etc. Similarly, flange 42 may have any desired shape or design, including a simple, substantially flat design which presents a single sealing surface as shown, or a more elaborate design which presents two or more sealing surfaces, such as the flange configurations disclosed in U.S. Pat. Nos. 5,348,752 and 5,439,132, the disclosures of which are hereby incorporated herein by reference.

Suitable materials from which support member 32 can be formed include, without limitation, polyvinyl chloride, polyethylene terephthalate, polystyrene, polyolefins such as high density polyethylene or polypropylene, paper pulp, nylon, polyurethane, and combinations thereof. The support member may be foamed or non-foamed as desired.

The height of the product 36 within the tray may be low profile or high profile. “Low profile” refers to packages wherein the product has a maximum height which is below the maximum height of support member 32, i.e., the level at which flange 42 is located. “High profile” products may also be packaged in accordance with the present invention, i.e., those having a maximum height which is above the level at which flange 42 is located so that the portion of the product which extends above the level of flange 42 will be in contact with lid 10.

As discussed above, the laminate may comprise a sealant film that is bonded to a print film. In some embodiments the laminate has an OTR that is about 4,000 cc at STP/m²/24 hr/atm or greater. An OTR of at least 4,000 cc at STP/m²/24 hr/atm may help facilitate the blooming of a meat product at points where the product may be in direct contact with the lidstock. In this regard, FIG. 2 illustrates a meat product 36 that is in direct contact with the laminate 10. The high OTR of the laminate 10 allows oxygen from the outside atmosphere to pass through the laminate 10 and contact portions of the product that may be in contact with the laminate. As a result, a sufficient amount of oxygen may pass through the laminate and help the product bloom.

The sealant film and print film each have oxygen transmission rates that are sufficiently high so that when combined, the resulting laminate has the desired OTR. In lidstock applications, the laminate should also be heat sealable to itself or to a support member such as a foam tray. In trap-print applications, the print film should have adequate stiffness so that a print image may be applied to the film. The sealant film and print film may also have a stiffness that helps facilitate lamination of each film to the other.

An adhesive having a high OTR may be used to bond the sealant film to the print film. In some embodiments, the OTR of the adhesive layer may be at least 7,000, 10,000, 13,000, 15,000, and 20,000 cc at STP/m²/24 hr/atm. The OTR of the adhesive may be determined from the OTR of the print film and sealant film and from the measured OTR of the laminate. In some embodiments, the print film and the sealant film may be laminated together with reactive surface modification methods, such as corona treatment.

### Sealant Film

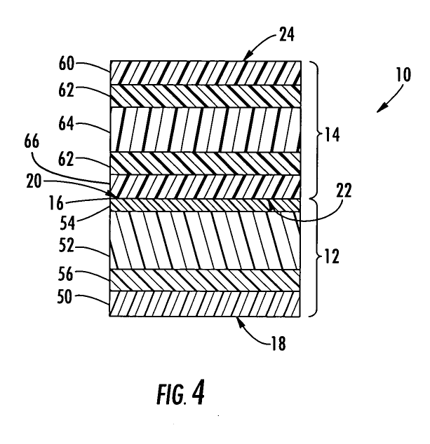

The sealant film 12 defines an outer (i.e., food side) surface 18 and an inner surface 22 opposite the outer surface. The sealant film may be monolayer, two-layer, or have three or more layers (as shown in FIG. 4). The outer surface may comprise a polymeric material (i.e., component or blend of components) that facilitates heat sealing the laminate 10 to support member 32.

To impart the desired OTR to the laminate, the sealant film has an OTR of at least 7,500 cc at STP/m²/24 hr/atm or greater. For example, in some embodiments, the sealant film 12 may have an OTR of at least about any of the following: 7,500, 10,000, 13,000, 16,000, and 20,000 cc at STP/m²/24 hr/atm measured at 73° F. and 0% relative humidity, measured according to ASTM D-3985.

The sealant film 12 may have any total thickness as long as it provides the desired properties (e.g., OTR, flexibility, stiffness, optics, strength) for the given packaging application of expected use. The sealant film may have a thickness of less than about any of the following: 10 mils, 5 mils, 4 mils, 3 mils, 2 mils, 1.5 mils, 1.4 mils, 1.3 mils, 1.2 mils, 1.1 mils, and 1 mil (A “mil” is equal to 0.001 inch.). The sealant film may also have a thickness of at least about any of the following: 0.3 mils, 0.4 mils, 0.5 mils, 0.6 mils, 0.7 mils, 0.75 mils, 0.8 mils, 0.9 mils, 1 mil, 1.2 mils, 1.4 mils, and 1.5 mils. In some embodiments the sealant film has a thickness from about 0.45 to 1.2 mils.

To help facilitate lamination of the sealant film to the print film, the sealant film has sufficient stiffness so that the sealant film may be amendable to the lamination process. Inadequate stiffness may result in difficulties during the lamination process and/or possible defects in the resulting laminate. In the context of this application, the term “stiffness” refers to the ability of the film to resist undesired extension facilitated by tension, or force, and temperatures imposed on the film by the laminating equipment. The stiffness of the film or a layer of the film may be correlated to the modulus of the film or layer. Suitable sealant films having acceptable stiffness may have a modulus that is at least 20,000 pounds per square inch (psi) or greater as measured according to ASTM D-882. In some embodiments, the sealant layer may have a modulus from about 20,000 to 40,000 psi, with a modulus of about 30,000 being somewhat more typical.

In some embodiments, the sealant film 12 and/or the print film 14 may also have a heat-shrinkable attribute. The heat shrinkable attribute helps improve the tightness to which the laminate may be heat-sealed to the package. In some applications, it may be desirable for the sealed package to have a tighter appearance. The sealant film 12 may have a free shrink measured at 200° F. in at least one direction (i.e., machine or transverse direction), in at least each of two directions (machine and transverse directions), or a total free shrink of at least about any of the following values: 5%, 7%, 10%, 15%, 20%, 30%, 40%, 50%, and 60%. Also, sealant film 12 may have a free shrink measured at 240° F. in at least one direction (machine or transverse directions), in each of at least two directions (machine and transverse directions), or a total free shrink measured of at least about any of the following values: 7%, 10%, 15%, 20%, 25%, 30%, 40%, 50%, 55%, 60%, 65%, and 70%.

As is known in the art, the total free shrink is determined by summing the percent free shrink in the machine (longitudinal) direction with the percentage of free shrink in the transverse direction. For example, a film which exhibits 50% free shrink in the transverse direction and 40% free shrink in the machine direction has a total free shrink of 90%.

Unless otherwise indicated, each reference to free shrink in this application means a free shrink determined by measuring the percent dimensional change in a 10 cm.times. 10 cm specimen when subjected to selected heat (i.e., at a certain temperature exposure) according to ASTM D 2732. Also, a reference herein to the shrink attributes of a film that is a component of a laminate refers to the shrink attributes of the film itself, which can be measured by separating the film from the laminate—for example, by using an appropriate solvent to dissolve the adhesive that bonds the films together to form the laminate.

The sealant or first film 12 may comprise a multilayer film (i.e., includes two or more layers) so that the layers in combination impart the desired performance characteristics to the sealant film. The sealant film 12 may, for example, comprise from 2 to 15 layers, at least 2 layers, at least 3 layers, at least 4 layers, from 2 to 4 layers, from 2 to 5 layers, and from 5 to 9 layers. As used herein, the term “layer” refers to a discrete film component which is coextensive with the film and has a substantially uniform composition. The oxygen permeability of each layer is such that the sealant film has an OTR of at least 7,500 cc at STP/m²/24 hr/atm.

In one alternative embodiment, the laminate may comprise a sealant film having a combination of a sealant layer and a bulk layer. In this regard, FIG. 1 illustrates a multilayer sealant film 12 having a sealant layer 50 forming the food-side or outer surface 18 and a bulk or core layer 52 forming the inner or non-food surface 22 of the sealant film. In this embodiment, the bulk layer may be adhesively bonded to the inner surface 20 of the print film. The multilayer sealant film may also include one or more additional layers such as a skin layer, stiffening layer, and tie layers, although the sealant film may have a composition such that tie layers are not incorporated in the sealant film. In this regard, FIG. 4 illustrates an alternative embodiment of the laminate wherein the sealant layer further includes a skin layer 54 and a stiffening layer 56. The number, permeability, orientation, and type of layers in the sealant film may be varied provided that the OTR of the sealant film is sufficiently high to produce a laminate having an OTR of at least 4,000 cc at STP/m²/24 hr/atm.

Below are some examples of combinations in which the alphabetical symbols designate the resin layers. Where the multilayer sealant film representation below includes the same letter more than once, each occurrence of the letter may represent the same composition or a different composition within the class that performs a similar function.
A/B, A/D, A/C/D, A/B/D, A/B/C/D, A/C/B/D, A/B/B/D, A/C/B/C/D, A/B/B/B/D,
A/B/C/B/D,
A/C/B/B/D, A/C/B/B/C/D, A/B/C/B/C/D, A/C/B/C/B/D, A/B/C/B/B/D, A/C/B/B/B/D,
A/C/B/C/B/D, A/C/B/B/B/C/D,
A/E/B, A/E/B/D.
“A” is the sealant layer (heat seal layer), as discussed below.
“B” is a core or bulk layer, as discussed below.
“C” is a tie layer, as discussed below.
“D” is a skin or print-side layer, as discussed below
“E” is a stiffening layer, as discussed below,

### Sealant Layer of the Sealant Film

With reference to FIGS. 1 and 4, sealant layer 50 forms the outer surface 18 of the laminate 10. Sealant layer 50 facilitates the heat-sealing of laminate 10 to another object, such as a support member or tray (e.g., see briefly FIG. 2, reference number 32). The sealant layer comprises a polymeric resin or combination of polymeric resins having a permeability that is sufficient to impart a desired OTR to the sealant film and that may be heat-sealable to the support member. The sealant layer may have a permeability of at least 1,500 (cc at STP)*mil/m²/24 hr/atm, with a permeability of about 6,000 (cc at STP)*mil/m²/24 hr/atm or greater being somewhat more typical. In some embodiments, the sealant layer may have a permeability selected from any one of the following: 6,000, 8,000, 10,000, 15,000, 18,000 and 20, 000 (cc at STP)*mil/m²/24 hr/atm or greater. Unless otherwise stated, any reference in this application to permeability was measured with ASTM-3985 at 73° F. and 0% relative humidity. In the context of this application, permeability is the OTR of a given polymeric material at 1 mil thickness. Permeability is generally indicative of a particular material's OTR at a thickness of 1 mil. OTR is generally not indicative of the performance of a particular material and may vary with the thickness of the film. In the context of this application, the requirements of the film are generally discussed in terms of OTR because the film may comprise multiple layers of varying thickness, whereas the requirements of the individual layers are generally discussed in terms of permeability of the material from which they may be composed.

The composition of the sealant layer may also be selected to help impart the desired stiffness properties to the sealant film. In some embodiments, the sealant layer 50 may have a modulus of at least one of the following: 20,000, 25,000, 30,000, 40,000, 50,000 psi or greater.

In some embodiments, the sealant layer may include selected components having a melt or softening point lower than that of the components of the other layers of the sealant film. The sealant layer may comprise a resin having a Vicat softening temperature of less than about any of the following values: 120° C., 115° C., 110° C., 105° C., 100° C., 95° C., and 90° C. The sealant layer may include one or more polymers having a melt-flow index of at least about any of the following: 1, 1.2, 1.4, 1.6, 1.8, 2, 2.2, 2.5, 2.8, 3, 3.5, 4, 5, 6, 7, 8, 9, 10, 15, and 20. In some embodiments, the sealant layer may include one or more polymers having a melting point of less than about any of the following: 130° C., 125° C., 120° C., and 115° C., in an amount of at least about any of the following percentages (based on the weight of the sealant layer): 30, 40, 50, 60, 70, 80, 90, and 100.

All references to “Vicat” values in this application are measured according to ASTM 1525 (1 kg). All references to melt-flow index in this application are measured according to ASTM D1238, at a temperature and piston weight as specified according to the material as set forth in the ASTM test method. All references to the melting point of a polymer or resin in this application refers to the melting peak temperature of the dominant melting phase of the polymer or resin as determined by differential scanning calorimetry according to ASTM D-3418.

The sealant layer may include one or more thermoplastic polymers including polyolefins, polystyrenes, polyurethanes, polyvinyl chlorides, and ionomers provided that the desired permeability of the sealant layer may be maintained.

Useful polyolefins include ethylene homo- and co-polymers and propylene homo- and co-polymers. Ethylene homopolymers include high density polyethylene (“HDPE”) and low density polyethylene (“LDPE”). Ethylene copolymers include ethylene/alpha-olefin copolymers (“EAOs”), ethylene/unsaturated ester copolymers, and ethylene/(meth)acrylic acid. (“Copolymer” as used in this application means a polymer derived from two or more types of monomers, and includes terpolymers, etc.).

EAOs are copolymers of ethylene and one or more alpha-olefins, the copolymer having ethylene as the majority mole-percentage content. In some embodiments, the comonomer includes one or more C₃-C₂₀ alpha-olefins, more preferably one or more C₄-C₁₂ alpha-olefins, and most preferably one or more C₄-C₈ alpha-olefins. Particularly useful alpha-olefins include 1-butene, 1-hexene, 1-octene, and mixtures thereof.

EAOs include one or more of the following: 1) medium density polyethylene (“MDPE”), for example having a density of from 0.93 to 0.94 g/cm³; 2) linear medium density polyethylene (“LMDPE”), for example having a density of from 0.926 to 0.94 g/cm³; 3) linear low density polyethylene (“LLDPE”), for example having a density of from 0.915 to 0.930 g/cm3; 4) very-low or ultra-low density polyethylene (“VLDPE” and “ULDPE”), for example having density below 0.915 g/cm³; and 5) homogeneous EAOs. Useful EAOs include those having a density of less than about any of the following: 0.925, 0.922, 0.92, 0.917, 0.915, 0.912, 0.91, 0.907, 0.905, 0.903, 0.9, and 0.898 grams/cubic centimeter. Unless otherwise indicated, all densities herein are measured according to ASTM D1505.

The polyethylene polymers may be either heterogeneous or homogeneous. As is known in the art, heterogeneous polymers have a relatively wide variation in molecular weight and composition distribution. Heterogeneous polymers may be prepared with, for example, conventional Ziegler Natta catalysts.

On the other hand, homogeneous polymers are typically prepared using metallocene or other single site-type catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from the Exxon Chemical Company (Baytown, Tex.) under the EXACT trademark, linear homogeneous ethylene/alpha-olefin copolymer resins available from the Mitsui Petrochemical Corporation under the TAFMER trademark, and long-chain branched, metallocene-catalyzed homogeneous ethylene/alpha-olefin copolymer resins available from the Dow Chemical Company under the AFFINITY trademark.

Another useful ethylene copolymer is ethylene/unsaturated ester copolymer, which is the copolymer of ethylene and one or more unsaturated ester monomers. Useful unsaturated esters include: 1) vinyl esters of aliphatic carboxylic acids, where the esters have from 4 to 12 carbon atoms, and 2) alkyl esters of acrylic or methacrylic acid (collectively, “alkyl(meth)acrylate”), where the esters have from 4 to 12 carbon atoms.

Representative examples of the first (“vinyl ester”) group of monomers include vinyl acetate, vinyl propionate, vinyl hexanoate, and vinyl 2-ethylhexanoate. The vinyl ester monomer may have from 4 to 8 carbon atoms, from 4 to 6 carbon atoms, from 4 to 5 carbon atoms, and preferably 4 carbon atoms.

Representative examples of the second (“alkyl(meth)acrylate”) group of monomers include methyl acrylate, ethyl acrylate, isobutyl acrylate, n-butyl acrylate, hexyl acrylate, and 2-ethylhexyl acrylate, methyl methacrylate, ethyl methacrylate, isobutyl methacrylate, n-butyl methacrylate, hexyl methacrylate, and 2-ethylhexyl methacrylate. The alkyl(meth)acrylate monomer may have from 4 to 8 carbon atoms, from 4 to 6 carbon atoms, and preferably from 4 to 5 carbon atoms.

The unsaturated ester (i.e., vinyl ester or alkyl (meth)acrylate) comonomer content of the ethylene/unsaturated ester copolymer may range from about 3 to about 18 weight %, and from about 8 to about 12 weight %, based on the weight of the copolymer. Useful ethylene contents of the ethylene/unsaturated ester copolymer include the following amounts: at least about 82 weight %, at least about 85 weight %, at least about 88 weight %, no greater than about 97 weight %, no greater than about 93 weight %, and no greater than about 92 weight %, based on the weight of the copolymer.

Representative examples of ethylene/unsaturated ester copolymers include ethylene/methyl acrylate, ethylene/methyl methacrylate, ethylene/ethyl acrylate, ethylene/ethyl methacrylate, ethylene/butyl acrylate, ethylene/2-ethylhexyl methacrylate, and ethylene/vinyl acetate.

Another useful ethylene copolymer is ethylene/(meth)acrylic acid, which is the copolymer of ethylene and acrylic acid, methacrylic acid, or both.

Useful propylene copolymer includes propylene/ethylene copolymers (“EPC”), which are copolymers of propylene and ethylene having a majority weight % content of propylene, such as those having an ethylene comonomer content of less than 10%, preferably less than 6%, and more preferably from about 2% to 6% by weight.

Ionomer is a copolymer of ethylene and an ethylenically unsaturated monocarboxylic acid having the carboxylic acid groups partially neutralized by a metal ion, such as sodium or zinc, preferably zinc. Useful ionomers include those in which sufficient metal ion is present to neutralize from about 15% to about 60% of the acid groups in the ionomer. The carboxylic acid is preferably “(meth)acrylic acid”—which means acrylic acid and/or methacrylic acid. Useful ionomers include those having at least 50 weight % and preferably at least 80 weight % ethylene units. Useful ionomers also include those having from 1 to 20 weight percent acid units. Useful ionomers are available, for example, from Dupont Corporation (Wilmington, Del.) under the SURLYN trademark.

The sealant layer 50 may have a composition such that any one of the above described polymers comprises at least about any of the following weight percent values: 30, 40, 45, 50, 55, 60, 65, 70, 75, 80, 85, 90, 95, and 100% by weight of the layer.

The thickness of the sealant layer is selected to provide sufficient material to effect a strong heat seal bond, yet not so thick so as to negatively affect the OTR or the manufacture (i.e., extrusion) of the sealant film, e.g., by lowering the melt strength of the film to an unacceptable level. The sealant layer may have a thickness of at least about any of the following values: 0.1 mils, 0.2 mils, 0.25 mils, 0.3 mils, 0.35 mils, 0.4 mils, 0.45 mils, 0.5 mils, and 0.6 mils. The sealant layer may have a thickness ranging from about 0.05 to about 6 mils, more preferably from about 0.1 to about 2 mils, and still more preferably from about 0.1 to about 0.5 mils. Further, the thickness of the sealant layer as a percentage of the total thickness of the sealant film may range (in ascending order of preference) from about 1 to about 50 percent, from about 5 to about 45 percent, from about 10 to about 45 percent, from about 15 to about 40 percent, from about 15 to about 35 percent, and from about 15 to about 30 percent. The sealant layer may have a thickness relative to the thickness of the sealant film of at least about any of the following values: 15%, 20%, 30%, 40%, and 50%.

### Bulk Layer of the Sealant Film

In some embodiments, the sealant film may include a bulk layer having a high permeability. A core or bulk layer 52l may comprise the outer surface 22 of the sealant film or may be an inner film layer having a primary purpose other than as a tie layer—for example, serving to provide a multilayer film with a desired level of strength, modulus, or optics. The bulk layer helps to maintain the integrity of the sealant film without sacrificing the oxygen transmission rate of the sealant film. In some embodiments, the bulk layer comprises a composition having a permeability from about 6,000 to 40,000 (cc at STP)*mil/m²/24 hr/atm, as measured with ASTM D-3985. The permeability of the bulk layer may be selected from about any of the following 6,000, 8,000, 10,000, 15,000, 18,000, 25,000, and 30,000 (cc at STP)*mil/m²/24 hr/atm or greater.

The composition of the bulk layer 52 is selected to provide additional strength to the sealant film while still maintaining a desired range of permeability. The thickness of the bulk or core layer may vary provided that the sealant film has the desired strength and OTR. The thickness of the bulk layer typically comprises between about 10 to 90 percent of the thickness of the sealant film.

In some embodiments, the sealant layer 50 may have a lower melting point than the melting point of the bulk layer 52. This differential in melting point values generally results in the bulk layer 52 having lower tackiness than the sealant layer 50, since a higher melting point polymer generally has less tackiness than a lower melting point polymer. As a result, the manufacture of the sealant film may be facilitated, because the sealant film is less likely to stick to itself when wound into a roll—and less likely to cause a reduction in processing speeds by sticking to processing equipment.

Suitable compositions for the core or bulk layer may include many of the compositions described above in connection with the sealant layer provided that the integrity of the sealant film is maintained without sacrificing the desired oxygen transmission rate of the sealant film. Exemplary compositions may include low-density polyethylene such as LLDPE, ULDPE, VLDPE; metallocene polyethylene such as metallocene VLDPE and metallocene ULDPE; ethylene vinyl acetate (EVA); alkyl (meth)acrylate, and blends thereof.

### Additional Layers of the Sealant Film

In some embodiments, the sealant film may also include a skin layer, stiffening layer, and one or more tie layers. In this regard, FIG. 4 illustrates a sealant film 12 having a stiffening layer 56 and a skin layer 54. In some embodiments, the skin layer 54 may provide the outer surface 22 to which the print film 14 may be directly laminated, as discussed in more detail below. The skin layer 54 may have a permeability of at least 1,500 (cc at STP)*mil/m²/24 hr/atm or greater

The skin layer 54 may include any of the thermoplastics or compositions as discussed above in conjunction with the sealant layer 50. The skin layer 54 may have a composition or thickness (or both) substantially similar to the sealant layer 50; or, the skin layer 54 may have a thickness and/or composition different from the sealant layer 50. For example, the skin layer 54 may comprise one or more polymers having a melting point higher than the melting point of the lowest melting point polymer of the sealant layer 50 by at least about any of the following values: 3° F., 5° F., 7° F., 10° F., 15° F., 20° F., 25° F., 30° F., and 35° F. The one or more higher melting point polymers of the skin layer may comprise a weight percentage of the skin layer of at least about any of the following values: 30, 40, 50, 60, 70, 75, 80, 85, 90, 95%.

Skin layer 54 may comprise a blend of polymers, some which may have a lower melting point than other polymers in the blend. In some embodiments, the blend of polymers in the skin layer may have a melting point higher than the lowest melting point of the polymers of the sealant layer 50. For example, the lowest melting point polymer of the skin layer may have a melting point higher by at least about any of the following values: 3° F., 5° F., 7°F., 10° F., 15° F., 20° F., 25° F., 30° F., and 35°F. Similar to case described above for the bulk layer, the differential in melting point values generally results in the skin layer 54 having lower tackiness than the sealant layer 50, since a higher melting point polymer generally has less tackiness than a lower melting point polymer. As a result, the manufacture of the sealant film may be facilitated, because the sealant film is less likely to stick to itself when wound into a roll—and less likely to cause a reduction in processing speeds by sticking to processing equipment.

The skin layer 54 may include one or more of any of the above-described polymers, for example, polyethylene, and/or polypropylene, either alone or in combination. The skin layer 54 may have a composition such that any one of the above-described polymers comprises at least about any of the following weight percent values: 30, 40, 45, 50, 55, 60, 65, 70, 75, 80, 85, 90, 95, and 100% by weight of the layer.

The thickness of the skin layer may vary provided that the desired rate of oxygen transmission through the skin layer is maintained. In some embodiments, the skin layer may have a thickness of from about 0.05 to about 5 mils, preferably from about 0.05 to about 2 mils, and more preferably from about 0.05 to about 0.5 mils. The thickness of the skin layer may range as a percentage of the total thickness of the sealant film of from about (in ascending order of preference) 1 to 50 percent, 3 to 45 percent, 5 to 40 percent, 7 to 35 percent, and 7 to 30 percent. Useful thicknesses for the skin layer include at least about any of the following values: 0.005 mils, 0.1 mils, 0.15 mils, 0.2 mils, and 0.25 mils.

The stiffening layer 56, if present in the sealant film, may help improve the stiffness of sealant film. In some embodiments, the stiffening layer may have a permeability of at least 1,500 (cc at STP)*mil/m²/24 hr/atm or greater. Suitable compositions for the stiffening layer may include LLDPE (heterogeneous or homogeneous), LMDPE (heterogeneous or homogeneous), polypropylene homopolymers and copolymers, propylene/ethylene copolymer (EPC), SBC (styrene butadiene copolymer), and blends thereof.

The tie layers, if present in the sealant film, may have a permeability so that the sealant film includes the desirable composition and other attributes as described below in conjunction with the tie layers of print film 14. In some embodiments, the adjacent layers of a multiple layer sealant film 12 may have sufficient compatibility so that a tie layer is not needed to form an inter-layer bond strength that is sufficiently strong for the expected end use.

Each of the additional layers may have a thickness of from about 0.05 to about 5 mils, preferably from about 0.1 to about 2 mils, and more preferably from about 0.2 to about 0.5 mils. The thickness of an additional layer may range as a percentage of the total thickness of the sealant film of from about (in ascending order of preference) 1 to 80 percent, 3 to 50 percent, 5 to 40 percent, 7 to 35 percent, and 7 to 30 percent.

### Print Film

The second film, also referred to as the “print film” comprises the outer film of the laminate. Referring to FIGS. 1 and 4, the print film 14 defines an inner surface 20 and an outer surface 24 opposite the inner surface. The outer surface of the print film forms the surface of the laminate that may engage a heat-sealing bar or similar device (not shown) that may be used in sealing the laminate to a support member. Suitable print films for use in the invention have a sufficient oxygen transmission rate to impart the desired OTR in the laminate and have a sufficient stiffness for lamination and reception of a printed image.

The print film preferably has a composition that imparts the desired OTR to the laminate. In some embodiments, the print film may have an OTR of at least 7,000 cc at STP/m²/24 hr/atm or greater. For example, in some embodiments, the print film 14 may have an OTR of at least about any of the following: 7,000, 8,000, 10,000, 13,000, 16,000, 17,500 and 20,000 cc at STP/m²/24 hr/atm measured at 73° F. and 0% relative humidity, measured according to ASTM D-3985. In some embodiments, the print film has an OTR of at least 20,000 cc at STP/m²/24 hr/atm or greater.

As discussed above for the sealant film, the print film may also have a stiffness that helps to facilitate printing of the print film and lamination between the print film and the sealant film. As discussed above, inadequate stiffness in either the print film or sealant film may result in difficulties during the lamination process and/or possible defects in the resulting laminate. In some cases, inadequate stiffness may result in poor repeat length control of the printed image. Suitable compositions for print film may have a modulus that is at least 45,000 psi or greater as measured according to ASTM D-882. In some embodiments, the print film may have a modulus from about 45,000 to 200,000 psi, with a modulus of about 110,000 being somewhat more typical.

In some embodiments, the print film 14 may also have a heat-shrinkable attribute similar to that of the sealant film 12 which is discussed above. In some embodiments, the sealant film and the print film may both include shrink attributes.

The print film 14 may comprise a multilayer film (i.e., includes two or more layers) so that the layers in combination impart the desired performance characteristics to the print film. The print film 14 may, for example, comprise from 2 to 15 layers, at least 2 layers, at least 3 layers, at least 4 layers, from 2 to 4 layers, from 2 to 5 layers, and from 5 to 9 layers. As used herein, the term “layer” refers to a discrete film component which is coextensive with the film and has a substantially uniform composition. The oxygen permeability of each layer is such that the print film has an OTR of at least 7,000 cc at STP/m²/24 hr/atm.

The print film 14 may have any total thickness as long as it provides the desired properties (e.g., OTR, flexibility, stiffness, optics, strength) for the given packaging application of expected use. In some embodiments, the print film may have a thickness of at least 0.45 mils. The print film may have a thickness of less than about any of the following: 10 mils, 5 mils, 4 mils, 3 mils, 2 mils, 1.5 mils, 1.4 mils, 1.3 mils, 1.2 mils, 1.1 mils, and 1 mil. (A “mil” is equal to 0.001 inch.). The sealant film may also have a thickness of at least about any of the following: 0.3 mils, 0.4 mils, 0.5 mils, 0.6 mils, 0.7 mils, 0.75 mils, 0.8 mils, 0.9 mils, 1 mil, 1.2 mils, 1.4 mils, and 1.5 mils. In some embodiments, the print film has a thickness from about 0.45 to 1.15 mils, with a thickness from about 0.6 to 0.75 mils being somewhat more typical.

In one alternative embodiment, the laminate may comprise a print film having a combination of an abuse layer, a bulk layer, and a stiffening layer. In this regard FIG. 1, illustrates a multilayer print film 14 having an abuse layer 60 forming the outer surface 24, a stiffening layer 64 forming a trap-printable surface, and a bulk or core layer 62 sandwiched between the abuse layer and the stiffening layer. In this embodiment, the stiffening layer may be adhesively bonded to the inner surface 22 of the sealant film. The multilayer sealant film may also include one or more additional layers such as an inner skin layer and one or more tie layers, although the print film may have a composition such that tie layers are not incorporated in the print film. In this regard, FIG. 4 illustrates an alternative embodiment of the laminate wherein the print film further includes an inner skin layer 66. The number, permeability, orientation, and type of layers in the print film may be varied provided that the OTR of the print film is sufficiently high to produce a laminate having an OTR of at least 4,000 cc at STP/m²/24 hr/atm. In some embodiments, the print film may comprise a structure having a stiffening layer and bulk layer sandwiched between an abuse layer and an inner skin layer, wherein the inner skin layer may be adhered to the bulk layer.

Below are some examples of combinations in which the alphabetical symbols designate the resin layers. Where the multilayer print film representation below includes the same letter more than once, each occurrence of the letter may represent the same composition or a different composition within the class that performs a similar function.
G/I, G/H/I, G/J/I, G/J/H/I, G/J/H/J/I, G/J/H/J/I/J/G, G/H/I/H/G, G/H/I/H, G/J/I/H, G/J/I/J/H, G/J/I/J/H/G,
G/H/I/H/I, G/J/I/H/G, G/H/I/J/G, G/H/I/H/I/H/G, G/J/I/H/I/J/G, G/H/I/H/I, G/I/H, G/H/I/K, G/H/I/H/K, G/H/I/J/K,
G/J/I/K, G/J/I/J/K, G/J/H/J/I/K, G/H/J/I/J/H/K, G/H/J/I/J/K, G/I/J/K, G/I/H/K, G/I/H/J/K, G/I/J/H/K
“G” is the abuse layer, as discussed below.
“H” is a core or bulk layer, as discussed below.
“I” is a stiffening layer as described below.
“J” is a tie layer, as discussed below.
“K” is an inner skin layer, as described below.

### Abuse Layer of the Print Film

The abuse layer 60 comprises the outer layer of the laminate. The print film 14 may be exposed to environmental stresses, for example once the print film is incorporated into laminate 10 and formed into a package 30. Such environmental stresses include abrasion and other abuse during processing and shipment. The outside or abuse layer 60 may provide enhanced resistance to abuse. Since the abuse layer 60 may be directly exposed to the heat seal bar of the heat-sealing equipment (not shown) when forming the sealed package 30, the abuse layer preferably provides heat-resistant characteristics to the print film 14 (and laminate 10) to help prevent “burn-through” during heat sealing. This is because in forming package 30 by conductance heat sealing the laminate 10 to support member (see briefly FIG. 2, reference number 32), sealant layer 50 is placed in contact with the support member 32, while the abuse layer 60 is proximate the heated bar of the heat sealing apparatus. The heat seal bar transfers heat through the abuse layer 60, through laminate 10, to the sealant layer 50 to form the heat seal 46 (see briefly FIG. 3) between the laminate and support member. Accordingly, abuse layer 60 may be exposed to the highest temperature during the sealing operation. The melting point of the abuse layer is typically greater than the temperature to which the abuse layer may be exposed during the heat seal operation. In some embodiments, the abuse layer has a melting point that is about 120° C. or greater as measured with ASTM D-3418, with a melting point of at least 135° C. or greater being somewhat more typical.

The abuse layer comprises a polymeric resin or combination of polymeric resins having a permeability that is sufficient to impart a desired OTR to the print film when combined with the additional layers of the print film. The abuse layer may have a permeability of at least 3,000 (cc at STP)*mil/m²/24 hr/atm, with a permeability of at least about 4,000 (cc at STP)*mil/m²/24 hr/atm being somewhat more typical. The thickness of the abuse layer may be varied provided that the desired properties of the abuse layer are maintained (e.g., OTR, stiffness, heat resistance). In some embodiments, the thickness of the abuse layer comprises from about 10 to 60 percent of the total thickness of the print film, with a thickness of about 25 percent being somewhat more typical. Useful thicknesses for the abuse layer include at least about any of the following values: 0.05 mils, 0.1 mils, 0.15 mils, 0.2 mils, 0.25 mils, 0.3 mils, 0.35 mils, 0.4 mils, and 0.5 mils.

The abuse layer 60 may include one or more of any of the following: polyolefins (e.g., polyethylenes, polypropylenes), polystyrenes, and polycarbonates. For example, the abuse layer may include any of these polymers in an amount of at least 50 weight %, more preferably at least 70%, still more preferably at least 90%, and most preferably 100% by weight of the layer. Useful polyethylenes, and polypropylenes include those described above.

### The Bulk Layer of the Print Film

In some embodiments, the print film may include a bulk layer having a high permeability. The bulk layer 62 may comprise an inner film layer having a primary purpose other than as a tie layer—for example, serving to provide a multilayer film with a desired level of strength, modulus, or optics. In some embodiments, the bulk layer comprises a composition having a permeability from about 3,000 to 40,000 (cc at STP)*mil/m²/24 hr/atm, as measured with ASTM D-3985. The permeability of the bulk layer may be selected from about any of the following 3,000, 3,000, 6,000, 10,000, 15,000, 20,000 25,000, and 30,000 (cc at STP)*mil/m²/24 hr/atm or greater.

The composition of the bulk layer 62 is selected to provide additional strength to the print film while still maintaining a desired range of permeability. The thickness of the bulk layer may vary provided that the print film has the desired strength and OTR. The thickness of the bulk layer typically comprises between about 10 to 80 percent of the thickness of the sealant film, with a thickness of about 35 percent being somewhat more typical.

The composition of the bulk layer may be chosen from a variety of different polymeric formulations provided that the print film has the desired oxygen transmission rate and integrity. Suitable compositions for the bulk layer 62 may include the compositions discussed previously in connection with the bulk layer of the sealant film.

### The Stiffening Layer of the Print Film

In some embodiments, the print film 14 may also include a stiffening layer 64 that may be laminated directly to the inner surface of the sealant film. The stiffening layer may help to improve the stiffness of the print film while still maintaining a sufficiently high permeability. The stiffening layer typically has a permeability of at least about 3,000 (cc at STP)*mil/m²/24 hr/atm as measured with ASTM D-3985. In some embodiments, the permeability of the stiffening layer is from about 3,000 to 20,000 (cc at STP)*mil/m²/24 hr/atm, with 8,000 (cc at STP)*mil/m²/24 hr/atm being somewhat more typical. The stiffness of the stiffening layer as determined in terms of modulus is typically from about 100,000 to 200,000 psi with a modulus from about 150,000 to about 175,000 being somewhat more typical. In some embodiments, the stiffening layer has a modulus of about 164,000 psi or greater.

The thickness of the stiffening layer may be varied provided that the desired stiffness of the print film and rate of oxygen transmission through the stiffening layer is maintained. In some embodiments, the stiffening layer has a thickness that is about 10 to 80 percent of the print film, with a thickness of about 40 percent being somewhat more typical.

Suitable compositions for the stiffening layer may include propylene homopolymers and copolymers, styrene block copolymer (SBC), and other polymeric materials that may have the desired permeability and stiffness.

In one alternative embodiment, the stiffening layer 64 of the print film may provide the surface upon which a printed image (e.g., printed information) is applied, in which case the layer is preferably capable of providing a surface that is compatible with the selected print ink system.

In some embodiments, the print film may also include additional layers such as one or more tie layers or an inner skin layer. Compositions and thicknesses of the additional layers are selected so that permeability of the layers is such that the print film has an OTR of at least 4,000 cc at STP/m²/24 hr/atm.

FIG. 4 illustrates an alternate embodiment of the laminate 10 wherein the print film 14 includes an inner skin layer 66. The inner skin layer may comprises a polymeric resin or combination of polymeric resins having a permeability that is sufficient to impart a desired OTR to the print film when combined with the additional layers of the print film. The inner skin layer may have a permeability of at least 3,000 (cc at STP)*mil/m²/24 hr/atm, with a permeability of at least about 4,000 (cc at STP)*mil/m²/24 hr/atm being somewhat more typical. The thickness of the inner skin layer may be varied provided that the desired properties of the skin layer are maintained (e.g., OTR, stiffness). In some embodiments, the thickness of the inner skin layer comprises from about 10 to 60 percent of the total thickness of the print film, with a thickness of about 25 percent being somewhat more typical. Useful thicknesses for the inner skin layer may include at least about any of the following values: 0.05 mils, 0.1 mils, 0. 1 5 mils, 0.2 mils, 0.25 mils, 0.3 mils, 0.35 mils, 0.4 mils, and 0.5 mils.

The inner skin layer 66 may include one or more of any of the following: polyolefins (e.g., polyethylenes, polypropylenes), polystyrenes, and polycarbonates, and combinations thereof. Useful polyethylenes, and polypropylenes include those described above.

The tie layers, if present, may comprise EVA; EMA; EAO's, including heterogeneous and homogeneous; polyethylene homopolymer; and chemically modified versions of the aforementioned materials, for example, compositions grafted with maleic anhydride.

### Additives of Sealant and/or Print Films

One or more layers of the sealant and or print films of laminate 10 may include one or more additives useful in packaging films, such as, antiblocking agents, slip agents, antifog agents, colorants, pigments, dyes, flavorants, antimicrobial agents, meat preservatives, antioxidants, fillers, radiation stabilizers, and antistatic agents. Such additives, and their effective amounts, are known in the art.

An antifog agent may advantageously be incorporated into sealant layer 50 or coated onto sealant layer 50, because sealant layer 50 forms the inner layer adjacent the interior of the sealed package 30 (see briefly FIG. 3). The incorporation of the antifog agent may occur either before or after lamination of the print film to the sealant film. Suitable antifog agents may fall into classes such as esters of aliphatic alcohols, esters of polyglycol, polyethers, polyhydric alcohols, esters of polyhydric aliphatic alcohols, polyethoxylated aromatic alcohols, nonionic ethoxylates, and hydrophilic fatty acid esters. Useful antifog agents include polyoxyethylene, sorbitan monostearate, polyoxyethylene sorbitan monolaurate, polyoxyethylene monopalmitate, polyoxyethylene sorbitan tristearate, polyoxyethylene sorbitan trioleate, poly(oxypropylene), polyethoxylated fatty alcohols, polyoxyethylated 4-nonylphenol, polyhydric alcohol, propylene diol, propylene triol, and ethylene diol, monoglyceride esters of vegetable oil or animal fat, mono- and/or diglycerides such as glycerol mono- and dioleate, glyceryl stearate, monophenyl polyethoxylate, and sorbitan monolaurate. The antifog agent is incorporated in an amount effective to enhance the antifog performance of the laminate 10.

### Optional Energy Treatment of the Sealant and/or Print Films

One or more of the thermoplastic layers of the sealant and/or print films—or at least a portion of the entire sealant and/or print films—may be cross-linked to improve the strength of the film, improve the orientation of the film, and help to avoid burn through during heat seal operations. Cross-linking may be achieved by using chemical additives or by subjecting one or more film layers to one or more energetic radiation treatments—such as ultraviolet, X-ray, gamma ray, beta ray, and high energy electron beam treatment—to induce cross-linking between molecules of the irradiated material. Useful radiation dosages include at least about any of the following: 5, 7, 10, 15, 20, 25, 30, 35, 40, 45, and 50 kGy (kiloGray). Useful radiation dosages include less than about any of the following: 130, 120, 110, 100, 90, 80, and 70 kGy (kiloGray). Useful radiation dosages include any of the following ranges: from 5 to 150, from 10 to 130, from 5 to 100, and from 5 to 75 kGy.

All or a portion of one or two surfaces the sealant film and/or the print film may be corona and/or plasma treated to change the surface energy of the film, for example, to increase the ability to print or laminate the film. One type of oxidative surface treatment involves bringing the sealant film into the proximity of an O₂— or N₂-containing gas (e.g., ambient air) which has been ionized. Exemplary techniques are described in, for example, U.S. Pat. No. 4,120,716 (Bonet) and U.S. Pat. No. 4,879,430 (Hoffinan), which are incorporated herein in their entirety by reference. The sealant film may be treated to have a surface energy of at least about 0.034 J/m², preferably at least about 0.036 J/m², more preferably at least about 0.038 J/m², and most preferably at least about 0.040 J/m².

### Manufacture and Orientation of the Sealant and Print Films

The sealant film 12 and print film 14 may each be separately manufactured by thermoplastic film-forming processes known in the art (e.g., tubular or blown-film extrusion, coextrusion, extrusion coating, flat or cast film extrusion). A combination of these processes may also be employed.

Each of the sealant film 12 and print film 14 may be oriented (i.e., before lamination discussed below) or non-oriented. Either or both of the sealant film 12 and the print film 14 may be oriented in either the machine (i.e., longitudinal) or the transverse direction, or in both directions (i.e., biaxially oriented), for example, in order to enhance the optics, strength, and durability of the film. Each of the sealant and print films may independently be oriented in at least one direction by one of the following ratios: at least about 2.5:1, from about 2.7:1 to about 10:1, at least about 2.8:1, at least about 2.9:1, at least about 3.0:1, at least about 3.1:1, at least about 3.2:1, at least about 3.3:1, at least about 3.4:1, at least about 3.5:1, at least about 3.6:1, and at least about 3.7:1. If it is desired to reduce the heat shrink attribute of a film to a desired level after the film is oriented, then the film may be heat set or annealed after orientation.

### Laminate

Referring back to FIGS. 2 and 3, the laminate 10 includes sealant film 12 laminated to print film 14 trapping the printed image 44 between the sealant and print films. Inside sealant film 12 and the outside print film 14 have free shrink attributes. The resulting laminate 10 presents a superior appearance upon sealing to the support member 32 (as described below).

Laminate 10 also has a heat-shrink attribute which may come into effect upon exposure to the elevated temperatures associated with sealing the laminate 10 to the support member. The laminate 10 may have any of a free shrink in at least one direction (machine or transverse direction), in at least each of two directions (machine and transverse directions), or a total free shrink of at least about any of the following values: 10%, 12%, 14%, 16%, 18%, 20%, and 25% when measured at 200° F.; and at least about 21%, 23%, 25%, 30%, 35%, and 40% when measured at 240° F. It is believed that heat sealing a laminate to a support member (e.g., tray) where the laminate has free shrinks of these values at both 200° F. and 240° F. reduces the amount and size of wrinkles and/or waves that may otherwise form in the lid of the resulting sealed package.

If laminate 10 has too much heat-shrink attribute for a given support member construction, then the laminate may cause support member 32 to bend, bow, or otherwise distort after exposure to the elevated temperatures associated with sealing the laminate 10 to the support member. Laminate 10 may have any of a free shrink in at least one direction (machine or transverse direction), in at least each of two directions (machine and transverse directions), or a total free shrink of less than about any of the following values: 70%, 60%, 50%, 40%, and 30% when measured at 200° F.; and less than about 90%, 80%, 70%, 60%, and 50% when measured at 240° F.

The thickness of the laminate may be less than about any of the following values: 10, 7, 5, 4, 3, 2.8, 2.5, 2.3, 2.2, 2.1, 2, 1.9, 1.8, 1.7 mils, 1.5, 1.4, 1.3, 1.2, 1.0. In some embodiments, the thickness of the laminate may be from about 1 to 2 mils, with a thickness of about 1.2 mils being somewhat more typical. The oxygen transmission rate attributes of the laminate are discussed above.

### Trap Printed Image

A printed image 44 is disposed (i.e., trap printed) between the sealant and print films at the interface between the inner surface 22 of sealant film 12 and the inner surface 20 of the print film 14. This may be accomplished by printing one or more images 44 on one or both of these surfaces before laminating the films together, so that upon lamination the printed images 44 are “trapped” between the two films. For example, the printed image may be “reverse trap printed” by printing the image onto surface 20 of the print film. In some embodiments, the printed image may be printed on the inner surface 22 of the sealant film.

The trapped print 44 is visible through a relatively transparent print film to provide information to the retail purchaser of the package. Accordingly, package 10 may be provided with consumer-specific information at the time of packaging at a centralized packaging facility, in the form of a printed image trapped within the laminate 10 used at part of the sealed package 30. The availability of trap printed information in laminate 10 reduces and potentially eliminates the need for additional package printing or labeling at the retail distribution point. The printed image 44 may include indicia such as product information, nutritional information, source identification, and other information, as discussed above. The laminate may include a plurality of repeating printed images for each package (i.e., “scatter print”) in which registration of the printed laminate 10 with the support member 32 is less important—or the printed image may require registration to place the printed image of the laminate in appropriate alignment with the support member 32 before sealing the lidstock to the support member (i.e., “registered print”).

To form the printed image, one or more layers of ink are printed onto the print surface. The ink is selected to have acceptable ink adhesion, appearance, and heat resistance once printed on the film. The film may be printed by any suitable method, such as rotary screen, gravure, or flexographic techniques. Inks and processes for printing on plastic films are known to those of skill in the art. See, for example, Leach & Pierce, The Printing Ink Manual, (5^{th} ed., Kluwer Academic Publishers, 1993), which is incorporated herein in its entirety by reference.

To improve the adhesion of the ink to the surface of the sealant or print film, the surface of the sealant or print film may be treated or modified before printing. Surface treatments and modifications include: i) mechanical treatments, such as corona treatment, plasma treatment, and flame treatment, and ii) primer treatment. Surface treatments and modifications are known to those of skill in the art. The flame treatment is less desirable for a heat-shrinkable film, since heat may prematurely shrink the film. The ink system should be capable of withstanding without diminished performance the temperature ranges to which it will be exposed during lamination, heat sealing, packaging, and end use.

### Appearance Characteristics of the Laminate

Each of laminate 10 and print film 14 may have low haze characteristics. Haze is a measurement of the transmitted light scattered more than 2.5° from the axis of the incident light. Haze is measured according to the method of ASTM D 1003, which is incorporated herein in its entirety by reference. All references to “haze” values in this application are by this standard. In some embodiments, the haze of either laminate 10 or print film 14 is no more than about (in ascending order of preference) 20%, 15%, 10%, 9%, 8%, 7%, 6%, 5%, 4%, and 3%.

Laminate 10 may have a gloss, as measured against the outer surface 24 of the print film 14 of at least about (in ascending order of preference) 40%, 50%, 60%, 63%, 65%, 70%, 75%, 80%, 85%, 90%, and 95%. These percentages represent the ratio of light reflected from the sample to the original amount of light striking the sample at the designated angle. All references to “gloss” values in this application are in accordance with ASTM D 2457 (45° angle).

In some embodiments, the laminate 10 is transparent (at least in the non-printed regions) so that the packaged food item 36 is visible through the laminate. “Transparent” as used herein means that the material transmits incident light with negligible scattering and little absorption, enabling objects (e.g., packaged food or print) to be seen clearly through the material under typical unaided viewing conditions (i.e., the expected use conditions of the material). If laminate 10 is transparent then both print film 14 and sealant film 12 are also transparent. Optionally, print film 14 may be transparent while sealant film is opaque, in which case laminate 10 is opaque while trap print 44 is still clearly visible through print film 14. In some embodiments, the transparency (i.e., clarity) of any of the laminate 10, sealant film 12, and print film 14 are at least about any of the following values: 65%, 70%, 75%, 80%, 85%, and 90%, as measured in accordance with ASTM D1746.

### Modulus of the Laminate

Laminate 10 preferably exhibits a Young's modulus sufficient to withstand the expected handling and use conditions. Young's modulus may be measured in accordance with one or more of the following ASTM procedures: D882; D5026; D4065, each of which is incorporated herein in its entirety by reference. The laminate 10 may have a Young's modulus of at least about 30,000 psi with a modulus of 45,000 to 200,000 psi or greater. A higher modulus film has an enhanced stiffness, which may help reduce the tendency of the trap printed image 44 to crack when the laminate is flexed. Further, it may be helpful in some embodiments that print film 14 have a high modulus at the elevated temperatures present when the laminate 10 is exposed to heat seal temperatures, for example, during the lidstock sealing process discussed below. Accordingly, in some embodiments the Young's modulus of the print film 14 may be greater than the modulus of the sealant film 12, for example, greater by at least about one of the following amounts: 25%, 30%, 35%, 40%, 45%, 50%, 60%, 70%, 75%, 80%, 90%, 100%, 125%, 150%, 175%, 200%, 400%, and 600%.

### Manufacture of the Laminate

To manufacture laminate 10, the inner surface 22 of the sealant film 12 is placed adjacent to or in contact with the inner surface 20 of print film 14 so that the films may be bonded together by a suitable lamination technique. Suitable lamination techniques are known in the art, and may include adhesive bonding, reactive surface modification (e.g., corona treatment, flame treatment, or plasma treatment), heat treatment, pressure treatment, heat-welding, and combinations thereof. In embodiments, where the print film and sealant film are laminated together in the absence of an adhesive, such as reactive surface modification, it may be desirable to use a composition suitable for such lamination. For example, in corona treatment suitable materials for the laminating layers may include EMA and EVA.

Print film 14 may be directly laminated to sealant film 12. The term “directly laminated” as used herein means that a first film is bonded to a second film by a suitable lamination method without an additional film between the first and second films. The first film (e.g., sealant film) may be considered as “directly laminated” to the second film (e.g., print film)—even if additional material is present between the first and second films—if the additional material is present primarily to facilitate the lamination of the first and second films (e.g., an adhesive used in adhesive lamination) or to form part of the trap print (e.g., a printed image) between the first and second films.

Laminate 10 has an inter-film bond strength sufficient to survive the expected packaging and end use conditions without delamination. The term “inter-film bond strength” as used herein means the amount of force required to separate or delaminate two directly laminated films, as measured in accordance with ASTM F904 where the Instron tensile tester crosshead speed is 5 inches per second, using five, 1-inch wide, representative samples. In some embodiments, the inter-film bond strength between sealant film 12 and print film 14 is at least about any of the following values: 0.5, 0.7, 0.9, 1, 1.1, 1.2, 1.3, 1.4, 1.5, 1.7, 2, and 2.5 pounds/inch.

### Sealed Package

The lidstock laminate 10 may be heat sealed to support member 32 to form sealed package 30.

### Support Member

Support member 32 is a component of package 30 in addition to laminate 10. Product 36 (e.g., a food product) may be disposed on or in support member 32. For example, meat products may be disposed in a tray-like support member comprising, for example, expanded polystyrene sheet material that has been thermoformed into a desired shape for supporting the meat product. Product support member 32 preferably is in the form of a tray having side walls 38 and base 40—which define cavity 34 into which the product 36 may be disposed. A peripheral flange 42 preferably extends from side walls 38 to provide a sealing surface for attachment of lid 10 to the support member 32 to enclose the product 36 within the cavity 34.

Although the drawings show support member 32 in one configuration, support member 32 may have any desired configuration or shape, such as rectangular, round, or oval. The support member may be substantially rigid, semi-rigid, or flexible. For example, the support member may have a 1% secant flex modulus of at least about any of the following values: 120,000, 140,000, 160,000, 180,000, 200,000, and 225,000 pounds/square inch.

Flange 42 may also have any desired shape or design, such as the substantially flat design presenting a single sealing surface as shown in the drawings, or a more elaborate design which presents two or more sealing surfaces, such as the flange configurations disclosed in U.S. Pat. Nos. 5,348,752 and 5,439,132, the disclosures of which are incorporated herein by reference.

Support member 32 may be formed from any material useful for the expected end use conditions, including polyvinyl chloride, polyethylene terephthalate, polystyrene, polyolefins (e.g., high density polyethylene or polypropylene), paper pulp, nylon, and polyurethane. The support member may be foamed or non-foamed as desired. Support member 32 may have oxygen transmission barrier attributes. In some embodiments, where it may be desirable to expose the product to a high oxygen atmosphere, the support member may have an OTR of at least 4,000 cc at STP/m²/24 hr/atm. In other embodiments, the support member may have an oxygen transmission rate less than about 4,000 cc at STP/m²/24 hr/atm.

### Manufacture of the Sealed Package

To make sealed package 30, the item to be packaged (e.g., product 36) may be placed onto support member 32. Then laminate 10 is placed over the support member so that the sealant film 12 of the laminate contacts the support member 32. Laminate 10 may be supplied from a larger web of the laminate, for example, from a roll that is unwound to supply laminate as needed.

A heated bar or member engages the perimeter of the lid 10 corresponding with the perimeter flange 42 of the support member to compress the lid against the flange of the support member. The resulting heat transfer and compression causes the sealant layer 50 of the laminate and the support member to soften and intermix with one another. In some embodiments, the support member 32 may include a surface layer 43 comprising a polymeric material that may be heat sealable to the sealant layer. In this embodiment, the resulting heat transfer and compression causes the sealant layer 50 of the laminate and the surface layer 43 to soften and intermix with one another. The heat from the sealing operation may also initiate shrinking of the heat shrinkable laminate to reduce the amount of wrinkles or waves that may otherwise form in the lid. The excess lid material extending beyond the flange may be trimmed by a cutting operation. Further, if the laminate is supplied from a roll, portions may be severed from the web after or simultaneously with the heat-welding of the laminate to support member 32. Laminate 10 may be severed by a conventional cutting device (e.g., a sharp cutting instrument or a thermal cutting device such as a heated wire or heated blade). The heating bar is removed to allow the sealed area to cool and form a sealed bond. A representative process for heat sealing a lid to a support member is described in U.S. Pat. No. 5,779,050 to Kocher, which was previously incorporated by reference.

The resulting heat-weld or heat-seal 46 preferably extends continuously around the upper surface of flange 42 to seal or enclose product 36 within package 30. In this manner, laminate 10 and support member 32 may form an enclosure for product 36 to protect it from contact with dirt, dust, moisture, liquid, and microbial contaminates. Product 36 may be packaged in a high oxygen atmosphere where desired in order to cause blooming of the product. Such products include fresh red meat products (e.g., beef, veal, lamb, and pork), poultry, fish, and cheese.

The sealing of the laminate 10 to support member 32 may be by one or more of the heat sealing methods, including thermal conductance sealing (as described above), impulse sealing, ultrasonic sealing, and dielectric sealing.

### Seal Strength

The resulting heat seal bond 46 between the laminate 10 and the support 38 is sufficiently strong to withstand the expected use conditions. For example, the heat seal bond strength may be at least about any of the following values: 0.5, 0.6, 0.7, 0.8, 0.9, 1, 1.3, 1.5, 1.8, 2, 2.5, 3, 3.5, 4, 4.5, 5, 5.5, 6, 6.5, 7, 7.5, and 8 pound/inch. The term “heat seal bond strength” as used herein means the amount of force required to separate the sealant layer of the laminate from the support member to which the sealant layer has been sealed, as measured in accordance with ASTM F88 where the Instron tensile tester crosshead speed is 5 inches per second, using five, 1-inch wide, representative samples.

Further, the resulting sealed package also has a seal strength sufficient to withstand the expected end use conditions, for example, a seal strength of at least about any of the following values: 3, 3.5, 4, 4.5, 5, 5.5, 6, 6.5, 7, and 7.5 pounds/inch. The term “seal strength” in conjunction with a sealed package refers to the maximum amount of force required to cause a cohesive or adhesive failure either within the laminate that is sealed to the support member, in the bond between the laminate and the support member of the package, or in the support member itself, measured in accordance with ASTM F88 by pulling representative samples of the film or laminate sealed to the support member using an Instron tensile tester with a crosshead speed of 5 inches per second and averaging the results from five, 1-inch wide, representative samples. ASTM F88 is incorporated herein in its entirety by reference.

As used herein, an “adhesive failure” is a failure in which the interfacial forces (e.g., valence forces or interlocking action or both) holding two surfaces together are overcome. A “cohesive failure” is one in which the molecular attractive forces holding together a layer composition are overcome.

In some embodiments, each of the sealed package 30, laminate 10, and the films incorporated in laminate 10 (e.g., sealant film 12 and print film 14) are non-peelable. The term “non-peelable” used in conjunction with a sealed package, laminate, or film means that the seal strength failure mode results in a jagged, tattered, or ragged separation—that is, one that does not cleanly, consistently, or reliably fail in the same manner and along the same position each time. In this sense, the seal strength failure mode of a non-peelable film or laminate is contrary to that of a peelable film, which is specifically designed to fail cleanly, consistently, and reliably in the same manner and along the same relative position each time, for example by incorporation of non-compatible thermoplastics and/or contaminates in two adjacent film layers to facilitate peeling and also by incorporating a mechanism such as a tab to initiate a peel separation, as described in U.S. Pat. No. 5,919,547 issued Jul. 6, 1999 to Kocher entitled “Laminate Having a Coextruded, Multilayer Film Which Delaminates and Package Made Therefrom,” which is incorporated herein in its entirety by reference.

In some embodiments, it may be desirable to load a plurality of sealed packages into a larger “master container” which may be manufactured from a suitable gas barrier material. Conventional “master container” or “master package” modified atmosphere packaging (MAP) systems include packaging perishable goods in a sealed container and then placing a plurality of these sealed packages in a “master container.” The “master container” may be evacuated of air and then filled with a gas blend that may include a mixture of any desirable gases which may include, for example, 40% carbon dioxide and 60% nitrogen for a low oxygen MAP system. The master container is then sealed to provide an airtight, sealed master container, containing sealed packages and a gas blend with a residual quantity of atmospheric oxygen. In high oxygen atmosphere applications, the master container may be filled with a high oxygen atmosphere so that each package may be maintained at a high oxygen atmosphere until the packages are removed from the master container.

In some embodiments, the master container may comprise an oxygen impermeable film or coating. The oxygen impermeable film or coating may include an oxygen barrier-forming layer or coating such as a film layer of a high oxygen barrier polymer (e.g. polyvinyl alcohol, ethylene vinyl alcohol copolymer and polyethylene naphthalate) which may also be coated with a further barrier polymer such as polyvinylidene chloride or its copolymers, or a coating of a substance selected from the group consisting of carbon (particularly in the crystalline form of diamond), aluminum, aluminum oxide, and oxides and nitrides of metals, including silicon oxides.

### EXAMPLES

The following examples are included for the purpose of illustrating the invention and should not be construed to be limiting.

In the comparatives and examples below, the following materials may be used:

Trap-printable laminates having the construction and composition shown in Tables 1 through 3 may be formed by adhesively laminating a First Film (i.e., sealant film) to a Second Film (i.e., print film) having a printed image on its inside surface.
“Adhesive” is a 2-part low barrier adhesive available from Rohm & Haas, comprising of a blend of MORFREE 400A and MOR-FREE Coreactant OX2;
“EPC” is a propylene/ethylene copolymer with 3.3% ethylene content and a melting point of 139° C. available from ExxonMobil under the trademark Escorene PD9302;
“SBC” is a styrene-butadiene block copolymer available from BASF under Styrolux 684D trademark;
“LLDPE” is a heterogeneous ethylene/octene copolymer having a melt-flow index of 1.0 and a density of 0.920 g/cc, available from the Dow Chemical Company (Midland, Mich.) under the Dowlex 2045 trademark;
“LMDPE” is a heterogeneous ethylene/octene copolymer having an octene content of 2.5 weight %, a melt-flow index of 2.5, and a density of 0.935 g/cc, available from the Dow Chemical Company (Midland, Mich.) under the Dowlex 2037 trademark;
“PE BLEND 1” is a 3:1 blend of LLDPE and LMDPE, both from The Dow Chemical Company as identified above.
“VLDPE BULK” or “VLDPE TIE” is a 0.905 density ethylene-octene copolymer available from The Dow Chemical Company under the Attane 4203 trademark; and
“VLDPE2 SEAL” is a 96:4 blend of (1) a 0.895 density homogeneous VLDPE available from the ExxonMobil Chemical Company under the Exact 4151 trademark and (2) a 0.920 density polyethylene homopolymer available from the ExxonMobil Chemical Company under the Escorene LD-134.09 trademark.

### Example 1

TABLE 1
Trap-Printable Laminate having an OTR of at least 4,000 cc at STP/m²/24 hr/atm

| | | | | Permeability* | | OTR* of Film |
|---|---|---|---|---|---|---|
| Film | Layer | Layer | Thickness of | (cc at STP)*mil/ | Modulus** | (cc at STP/ |
| Designation | Designation | Composition | layer (mils) | m²/24 hr/atm | (psi) | m²/24 hr/atm) |
| Print Film | | | 0.75 | | 77,000 | 8,900 |
| | Abuse Layer | LLDPE | 0.15 | 6,500 | 45,000 | |
| | Bulk Layer | VLDPE BULK | 0.30 | 19,000 | 15,000 | |
| | Stiffening | EPC | 0.30 | 4,100 | 155,000 | |
| | layer | | | | | |
| Adhesive*** | | | | | | 15,600 |
| Sealant Film | | | | | 31,000 | 14,700 |
| | Bulk Layer | LLDPE | 0.36 | 6,500 | 45,000 | |
| | Sealant Layer | VLDP2 SEAL | 0.24 | 19,000 | 10,000 | |

*As measured with ASTM D-3985
**As measured with ASTM D-882
***Low barrier adhesive available from Rohm &Haas

### Example 2

TABLE 2
Trap-Printable Laminate having an OTR of at least 4,000 cc at STP/m²/24 hr/atm

| | | | | Permeability* | | OTR* of Film |
|---|---|---|---|---|---|---|
| Film | Layer | Layer | Thickness of | (cc at STP)*mil/ | Modulus** | (cc at STP/ |
| Designation | Designation | Composition | layer (mils) | m²/24 hr/atm | (psi) | m²/24 hr/atm) |
| Print Film | | | 0.58 | | 70,500 | 19,700 |
| | Abuse Layer | LLDPE | 0.06 | 6,500 | 45,000 | |
| | Bulk Layer | VLDPE BULK | 0.32 | 19,000 | 15,000 | |
| | Stiffening | SBC | 0.20 | 4,100 | 165,000 | |
| | layer | | | | | |
| Adhesive*** | | | | | | 15,600 |
| Sealant Film | | | 1.30 | | 27,500 | 7,500 |
| | Bulk Layer | LLDPE | 0.65 | 6,500 | 45,000 | |
| | Sealant Layer | VLDP2 SEAL | 0.65 | 19,000 | 10,000 | |

*As measured with ASTM D-3985
**As measured with ASTM D-882
***Low barrier adhesive available from Rohm & Haas

### Example 3

TABLE 3
Trap-Printable Laminate having an OTR of at least 4,000 cc at STP/m²/24 hr/atm

| | | | | Permeability* | | OTR* of Film |
|---|---|---|---|---|---|---|
| Film | Layer | Layer | Thickness of | (cc at STP)*mil/ | Modulus** | (cc at STP/ |
| Designation | Designation | Composition | layer (mils) | m²/24 hr/atm | (psi) | m²/24 hr/atm) |
| Print Film | | | 1.00 | | 115,000 | 7,000 |
| | Abuse Layer | EPC | 0.34 | 4,100 | 155,000 | |
| | Bulk Layer | VLDPE BULK | 0.31 | 19,000 | 15,000 | |
| | Stiffening | SBC | 0.35 | 8,100 | 165,000 | |
| | Layer | | | | | |
| Adhesive*** | | | | | | 15,600 |
| Sealant Film | | | 0.50 | | 20,500 | 24,000 |
| | Bulk Layer | LLDPE | 0.15 | 6,500 | 45,000 | |
| | Sealant Layer | VLDPE2 SEAL | 0.35 | 19,000 | 10,000 | |

*As measured with ASTM D-3985
**As measured with ASTM D-882
***Low barrier adhesive available from Rohm & Haas

### Example 4

TABLE 4
Trap-Printable Laminate having an OTR of at least 5,000 cc at STP/m²/24 hr/atm

| | | | | Permeability* | | OTR* of Film |
|---|---|---|---|---|---|---|
| Film | Layer | Layer | Thickness of | (cc at STP)*mil/ | Modulus** | (cc at STP/ |
| Designation | Designation | Composition | layer (mils) | m²/24 hr/atm | (psi) | m²/24 hr/atm) |
| Print Film | | | 0.60 | | 110,000 | 12,900 |
| | Abuse Layer | EPC | 0.15 | 4,100 | 155,000 | |
| | Bulk Layer | VLDPE BULK | 0.21 | 19,000 | 15,000 | |
| | Stiffening | SBC | 0.24 | 8,100 | 165,000 | |
| | layer | | | | | |
| Adhesive | | | | | | 15,600 |
| Sealant Film | | | | | 28,000 | 17,500 |
| | Bulk Layer | VLDPE BULK | 0.40 | 19,000 | 15,000 | |
| | Sealant Layer | PE BLEND 1 | 0.20 | 5,500 | 55,000 | |

*As measured with ASTM D-3985
**As measured with ASTM D-882

### Example 5

TABLE 5
Trap-Printable Laminate having an OTR of at least 5,000 cc at STP/m²/24 hr/atm

| | | | | Permeability* | | OTR* of Film |
|---|---|---|---|---|---|---|
| Film | Layer | Layer | Thickness of | (cc at STP)*mil/ | | (cc at STP/ |
| Designation | Designation | Composition | layer (mils) | m²/24 hr/atm | Modulus** (psi) | m²/24 hr/atm) |
| Print Film | | | 0.60 | | 106,000 | 13,500 |
| | Abuse Layer | EPC | 0.07 | 4,100 | 155,000 | |
| | Bulk Layer | VLDPE BULK | 0.11 | 19,000 | 15,000 | |
| | Stiffening | SBC | 0.24 | 8,100 | 165,000 | |
| | Layer | | | | | |
| | Bulk Layer | VLDPE BULK | 0.11 | 19,000 | 15,000 | |
| | Inner Skin | EPC | 0.07 | 4,100 | 155,000 | |
| | Layer | | | | | |
| Adhesive | | | | | | 15,600 |
| Sealant Film | | | 0.65 | | 27,000 | 16,700 |
| | Skin Layer | PE BLEND 1 | 0.07 | 5,500 | 55,000 | |
| | Bulk Layer | VLDPE BULK | 0.33 | 19,000 | 15,000 | |
| | Stiffening | PE BLEND 1 | 0.14 | 5,500 | 55,000 | |
| | Layer | | | | | |
| | Sealant Layer | VLDPE2 SEAL | 0.12 | 19,000 | 10,000 | |

*As measured with ASTM D-3985
**As measured with ASTM D-882

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A laminate comprising:
a first film having inner and outer surfaces, an oxygen transmission rate of at least 7,500 cc at STP/m2/24 hr/atm and a modulus of at least 20,000 psi; and
a second film having inner and outer surfaces, an oxygen transmission rate of at least 7,000 cc at STP/m²/24 hr/atm and a modulus of at least 45,000 psi, wherein the inner surface of said first film is laminated to the inner surface of said second film to produce a laminate having an oxygen transmission rate of at least 4,000 cc at STP/m²/24 hr/atm.

2. The laminate according to claim 1, wherein said first film is laminated to said second film with an adhesive layer having an oxygen transmission rate of at least 7,000 cc at STP/m²/24 hr/atm.

3. The laminate according to claim 2, wherein said first film comprises a first bulk layer defining the inner surface of said first film, said first bulk layer having a permeability from about 6,000 to 40,000 (cc at STP)*mil/m²/24 hr/atm.

4. The laminate according to claim 1, wherein said first film comprises a sealant layer and a first bulk layer, said sealant layer having a permeability of at least 1,500 (cc at STP)*mil/m²/24 hr/atm, and said first bulk layer having a permeability of at least 6,000 (cc at STP)*mil/m²/24 hr/atm.

5. The laminate according to claim 4, wherein said sealant layer comprises a polymer selected from the group consisting of homogeneous linear low density polyethylene, heterogeneous linear low density polyethylene, homogeneous very low density polyethylene, heterogeneous very low density polyethylene, ionomer, ethylene vinyl acetate, and combinations thereof.

6. The laminate according to claim 4, wherein said first bulk layer comprises a polymer selected from the group consisting of homogeneous very low density polyethylene, heterogeneous very low density polyethylene, ethylene vinyl acetate, ethylene butyl acrylate, and combinations thereof.

7. The laminate according to claim 1, wherein the second film comprises an outer abuse layer, a stiffening layer, and a second bulk layer sandwiched between said abuse layer and said stiffening layer, said abuse layer having a permeability of at least 3,000 (cc at STP)*mil/m²/24 hr/atm and a melting point of at least 124° C., said stiffening layer having a permeability of at least 3,000 (cc at STP)*mil/m²/24 hr/atm and a modulus of at least 100,000 psi, and said second bulk layer having a permeability of at least 3,000 (cc at STP)*mil/m²/24 hr/atm.

8. The laminate according to claim 7, wherein said abuse layer comprises a polymer selected from the group consisting of polypropylene, propylene/ethylene copolymer, linear medium density, linear low density polyethylene, metallocene polyethylene, and combinations thereof, said stiffening layer comprises a polymer selected from the group consisting of propylene/ethylene copolymer, styrene-butadiene copolymer and combinations thereof, and said second bulk layer comprises a polymer selected from the group consisting of homogeneous very low density polyethylene, heterogeneous very low density polyethylene, ethylene vinyl acetate, ethylene butyl acrylate, and combinations thereof.

9. The laminate according to claim 1, wherein said first film has an oxygen transmission rate of at least 18,000 cc at STP/m²/24 hr/atm and said second film has an oxygen transmission rate of at least 13,000 cc at STP/m²/24 hr/atm so that said laminate has an oxygen transmission rate of at least 5,000 cc at STP/m²/24 hr/atm.

10. The laminate according to claim 9, wherein said first film has a modulus of at least 20,000 psi and said second film has a modulus of at least 70,000 psi.

11. The laminate according to claim 1, wherein a trap-printed image is disposed between said first and second films.

12. A trap-printed laminate comprising:
a first film having an oxygen transmission rate of at least 16,000 cc at STP/m²/24 hr/atm and a modulus of at least 25,000 psi;
a second film adhesively bonded to said film and having an oxygen transmission rate of at least 13,000 cc at STP/m²/24 hr/atm and a modulus of at least 100,000 psi; and
an image disposed between said first and second films, wherein said laminate has an oxygen transmission rate of at least 5,000 cc at STP/m²/24 hr/atm.

13. The trap-printed laminate according to claim 12, wherein said first film comprises:
an outer sealant layer comprising metallocene very low density polyethylene, said sealant layer having a permeability of at least 18,000 (cc at STP)*mil/m²/24 hr/atm; and
a first bulk layer comprising very low density polyethylene, said bulk layer having a permeability of at least 18,000 (cc at STP)*mil/m²/24 hr/atm.

14. The trap-printed laminate according to claim 12, wherein said second film comprises:
an abuse layer comprising propylene/ethylene copolymer, said abuse layer having a having a permeability of at least 3,500 (cc at STP)*mil/m²/24 hr/atm;
a stiffening layer comprising styrene-butadiene copolymer, said stiffening layer having a permeability of at least 8,000 (cc at STP)*mil/m²/24 hr/atm; and
a second bulk layer sandwiched between said abuse layer and said stiffening layer, said second bulk layer comprising very low density polyethylene, and having a permeability of at least 18,000 (cc at STP)*mil/m²/24 hr/atm.

15. The trap-printed laminate according to claim 14, wherein said second film further comprises an inner skin layer that is laminated to said first film.

16. The trap-printed laminate according to claim 12, further comprising an adhesive between first and second films, said adhesive having an oxygen transmission rate of at least 10,000 cc at STP/m²/24 hr/atm.

17. A package for sealing a product therein, said package comprising:
a support member defining an interior space for disposing a product therein;
a laminate bonded to said support member such that the product is enclosed between said support member and said laminate, said laminate comprising:
1) a first film having an oxygen transmission rate of at least 7,500 cc at STP/m²/24 hr/atm and a modulus of at least 20,000 psi;
2) a second film having an oxygen transmission rate of at least 7,000 cc at STP/m²/24 hr/atm and a modulus of at least 45,000 psi; and
3) an image disposed between said first and second films, wherein said laminate has an oxygen transmission rate of at least 4,000 cc at STP/m²/24 hr/atm.

18. The package according to claim 17, wherein said image is bonded to said second film.

19. The package according to claim 17, wherein said first film is adhesively laminated to said second film with an adhesive having an oxygen transmission rate of at least 10,000 cc at STP/m²/24 hr/atm.

20. The package according to claim 17, wherein said bond between said laminate and said support member comprises a heat seal, ultrasonic seal, or dielectric seal.

21. The package according to claim 17, wherein the support member comprises polyvinyl chloride, polyethylene terephthalate, polystyrene, high density polyethylene, polypropylene, paper pulp, nylon, polyurethane, or combinations thereof.

22. The package according to claim 17, wherein the package includes an interior space having a high oxygen atmosphere.

23. An apparatus for shipping and storing a perishable product, comprising:
a sealed pouch comprising a barrier film and having one or more of the packages of claim 17 disposed therein.
